(19) United States
(12) Patent Application Publication
(10) Pub. No.: US 2015/0304762 A1
(43) Pub. Date: Oct. 22, 2015

(54) Earphone Attachment System

(71) Applicant: Renee Schwartz, Garwood, NJ (US)

(72) Inventor: Renee Schwartz, Garwood, NJ (US)

(21) Appl. No.: 14/255,021

(22) Filed: Apr. 17, 2014

(51) Int. Cl. H04R 1/10

(52) U.S. Cl. CPC H04R 1/1091

(57) ABSTRACT

An earphone attachment system protects an earphone while also allowing a user to personalize the appearance of their earphone. The system includes an earphone having an ear end and a cord. The ear end is coupled to the cord. The ear end includes a speaker and a housing wherein the housing is coupled to and extends around the speaker. The speaker is removably insertable into a user's ear for listening to audio signals produced through the speaker. An earphone attachment is coupled to the ear end. The earphone attachment has a top end, a bottom end and a perimeter surface coupled to and extending between the top end and the bottom end. A decorative object is coupled to the earphone attachment.

### BACKGROUND OF THE DISCLOSURE

### Field of the Disclosure

The disclosure relates to earphone systems and more particularly pertains to a new earphone system for protecting an earphone while also allowing a user to personalize the appearance of their earphone.

### SUMMARY OF THE DISCLOSURE

An embodiment of the disclosure meets the needs presented above by generally comprising an earphone having an ear end and a cord. The ear end is coupled to the cord. The ear end includes a speaker and a housing wherein the housing is coupled to and extends around the speaker. The speaker is removably insertable into a user's ear for listening to audio signals produced through the speaker. An earphone attachment is coupled to the ear end. The earphone attachment has a top end, a bottom end and a perimeter surface coupled to and extending between the top end and the bottom end. A decorative object is coupled to the earphone attachment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side perspective view of an earphone attachment system according to an embodiment of the disclosure.

FIG. 2 is a detailed perspective view of an embodiment of the disclosure.

FIG. 3 is a side view of an embodiment of the disclosure.

FIG. 4 is a back view of an embodiment of the disclosure.

FIG. 5 is a front view of a decorative object of an alternative embodiment of the disclosure.

FIG. 6 is a front view of a decorative object of an alternative embodiment of the disclosure.

FIG. 7 is a front view of a decorative object of an alternative embodiment of the disclosure.

### DESCRIPTION OF THE PREFERRED EMBODIMENT

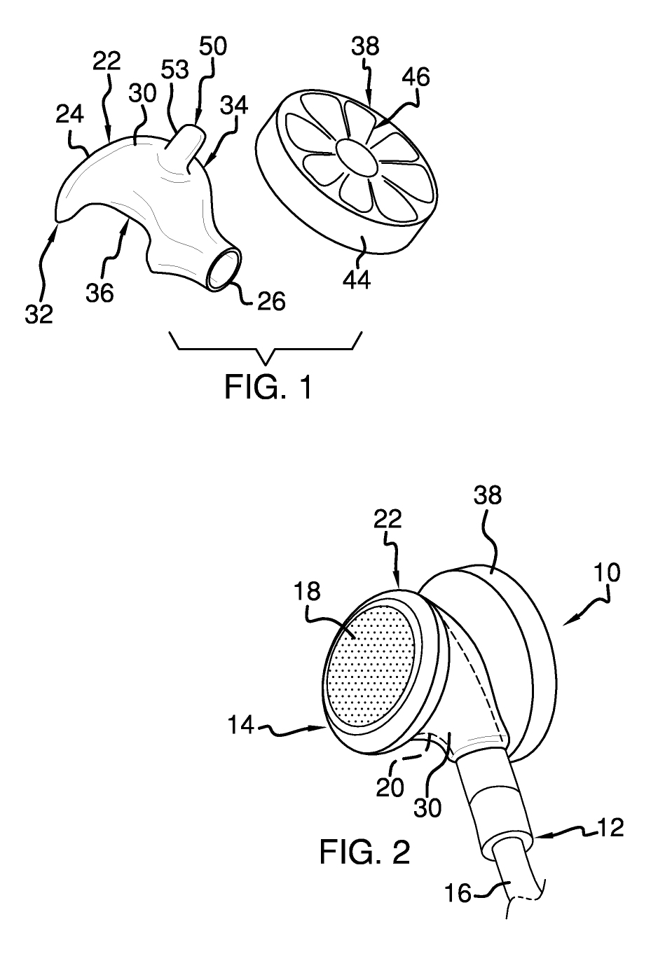

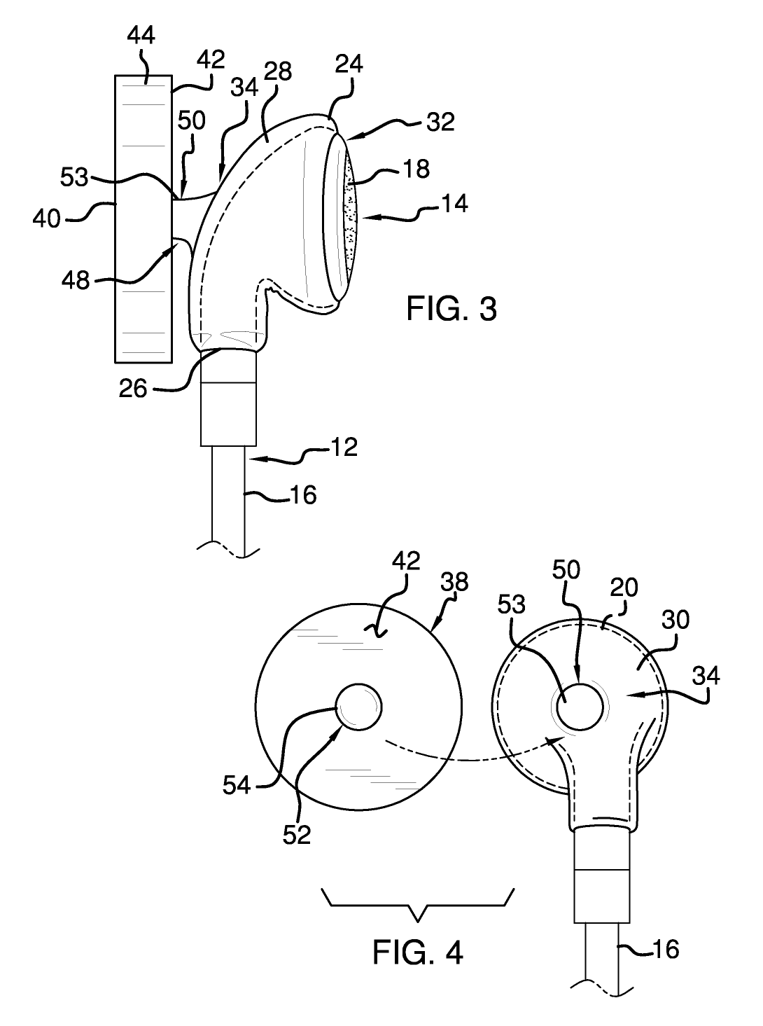

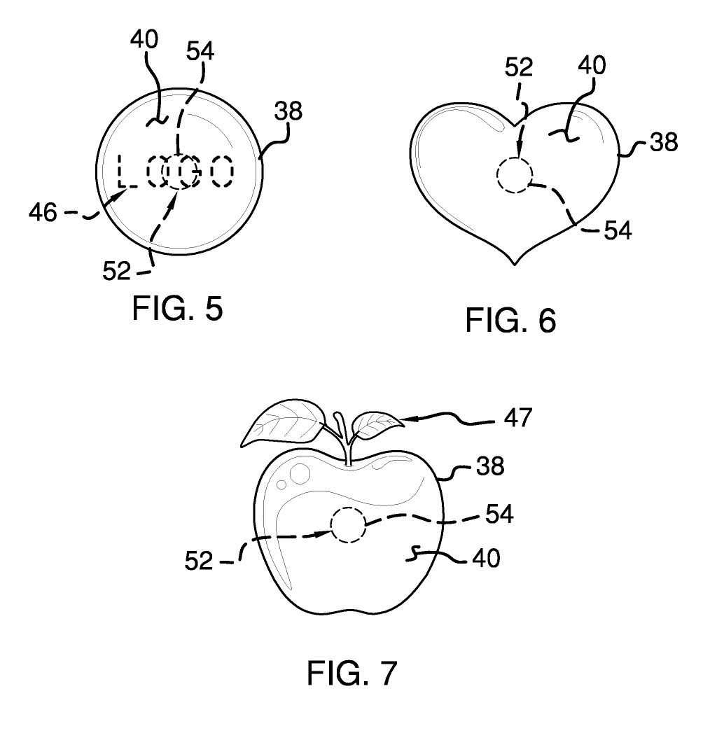

With reference now to the drawings, and in particular to FIGS. 1 through 7 thereof, a new earphone system embodying the principles and concepts of an embodiment of the disclosure and generally designated by the reference numeral 10 will be described.

As best illustrated in FIGS. 1 through 7, the earphone attachment system 10 generally comprises an earphone 12, which may be of any conventional design, having an ear end 14 and a cord 16. The ear end 14 is coupled to the cord 16. The ear end 14 includes a speaker 18 and a housing 20 wherein the housing 20 is coupled to and extends around the speaker 18. The speaker 18 is removably insertable into a user's ear for listening to audio signals produced through the speaker 18.

An earphone attachment 22 is coupled to the ear end 14. The earphone attachment 22 has a top end 24, a bottom end 26 and a perimeter surface 28 coupled to and extending between the top end 24 and the bottom end 26. A longitudinal axis extends through the earphone attachment 22 between the top end 24 and the bottom end 26. The earphone attachment 22 defines a sleeve 30 positionable over the ear end 14 for covering and protecting the ear end 14. The bottom end 26 of the earphone attachment 22 is open to permit the cord 16 to pass therethrough. The perimeter surface 28 of the earphone attachment 22 includes a first side 32 opposite a second side 34. The first side 32 may have an opening 36 extending therein wherein the speaker 18 is received through the opening 36. The earphone attachment 22 may be comprised of an elastomeric material in order to better fit around earphones 12 of various types.

A decorative object 38 is coupled to the earphone attachment 22. The decorative object 38 has a first face 40, a second face 42 and a perimeter wall 44 coupled to and extending between the first face 40 and the second face 42. The decorative object 38 may have any suitable shape, and may, for example, resemble a heart, an apple or the like. The first face 40 of the decorative object 38 may have indicia 46, such as a logo or a design positioned thereon. Alternatively, or in addition to the indicia 46, the first face 40 may have a decorative accessory 47 attached thereto, which may project outwardly therefrom, as shown in FIG. 7.

A coupler 48 removably couples the earphone attachment 22 to the decorative object 38. The coupler 48 includes a first mating member 50 coupled to the earphone attachment 22 and a second mating member 52 coupled to the decorative object 38. The first mating member 50 is complementary relative to the second mating member 52 such that the first 50 and second 52 mating members are engageable to releasably couple the earphone attachment 22 to the decorative object 38. The first mating member 50 may be integrally coupled to the earphone attachment 22. The first mating member 50 may be attached to the second side 34 of the perimeter surface 28. The first mating member 50 may comprise a prong 53 extending outwardly from the earphone attachment 22 and, in particular, may extend outwardly from the earphone attachment 22 in a direction transverse relative to the longitudinal axis extending through the earphone attachment 22. The second mating member 52 may be coupled to the second face 42 of the decorative object 38. The second mating member may define a cavity 54 extending into the decorative object 38. The prong 53 is received within and frictionally engages the cavity 54 to releasably couple the earphone attachment 22 to the decorative object 38. The first face 40 of the decorative object 38 extends in a first direction when the decorative object 38 is coupled to the earphone attachment 22. The speaker 18 extends in a second direction opposite the first direction when the ear end 14 of the earphone 12 is attached to the earphone attachment 22.

In use, the earphone attachment 22 is positioned around the ear end 14 of the earphone 12 to protect and cover the ear end 14 of the earphone 12. A decorative object 38 of the user's choice is then coupled to the earphone attachment 22 via the first 50 and second 52 mating members. The speaker 18 is then placed into the user's ear to allow the user to listen to audio signals produced through the speaker 18. In this manner, the system 10 allows the user to change the look of their earphones 12 by selecting a desired decorative object 38 to couple to the earphone attachment 22, while at the same time protecting the earphone 12 against damage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An earphone attachment system comprising:
an earphone having an ear end and a cord, said ear end being coupled to said cord, said ear end including a speaker and a housing wherein said housing is coupled to and extends around said speaker, said speaker being removably insertable into a user's ear for listening to audio signals produced through said speaker;
an earphone attachment coupled to said ear end, said earphone attachment having a top end, a bottom end and a perimeter surface coupled to and extending between said top end and said bottom end; and
a decorative object coupled to said earphone attachment.

2. The system of claim 1, further comprising said earphone attachment defining a sleeve positionable over said ear end for covering and protecting said ear end.

3. The system of claim 2, further comprising said bottom end of said earphone attachment being open to permit said cord to pass therethrough.

4. The system of claim 2, further comprising wherein said perimeter surface of said earphone attachment includes a first side opposite a second side, said first side having an opening extending therein wherein said speaker is received through said opening.

5. The system of claim 1, further comprising said earphone attachment being comprised of an elastomeric material.

6. The system of claim 1, further comprising a coupler removably coupling said earphone attachment to said decorative object.

7. The system of claim 6, further comprising wherein said coupler includes a first mating member coupled to said earphone attachment and a second mating member coupled to said decorative object, said first mating member being complementary relative to said second mating member such that said first and second mating members are engageable to releasably couple said earphone attachment to said decorative object.

8. The system of claim 7, further comprising said first mating member being integrally coupled to said earphone attachment.

9. The system of claim 7, further comprising:
said first mating member comprising a prong extending outwardly from said earphone attachment; and
said second mating member defining a cavity extending into said decorative object, said prong being received within and engaging said cavity to releasably couple said earphone attachment to said decorative object.

10. The system of claim 7, further comprising wherein said perimeter surface of said earphone attachment includes a first side opposite a second side, said first mating member being attached to said second side of said perimeter surface.

11. The system of claim 7, further comprising a longitudinal axis extending through said earphone attachment between said top end and said bottom end of said earphone attachment, said first mating member extending outwardly from said earphone attachment in a direction transverse relative to said longitudinal axis extending through said earphone attachment.

12. The system of claim 7, further comprising said decorative object having a first face, a second face and a perimeter wall coupled to and extending between said first face and said second face, said second mating member being coupled to said second face.

13. The system of claim 12, further comprising said first face extending in a first direction when said decorative object is coupled to said earphone attachment, said speaker extending in a second direction opposite said first direction when said ear end of said earphone is attached to said earphone attachment.

14. An earphone attachment system comprising:
an earphone having an ear end and a cord, said ear end being coupled to said cord, said ear end including a speaker and a housing wherein said housing is coupled to and extends around said speaker, said speaker being removably insertable into a user's ear for listening to audio signals produced through said speaker;
an earphone attachment coupled to said ear end, said earphone attachment having a top end, a bottom end and a perimeter surface coupled to and extending between said top end and said bottom end, a longitudinal axis extending through said earphone attachment between said top end and said bottom end of said earphone attachment, said earphone attachment defining a sleeve positionable over said ear end for covering and protecting said ear end, said bottom end of said earphone attachment being open to permit said cord to pass therethrough, said perimeter surface of said earphone attachment including a first side opposite a second side, said first side having an opening extending therein wherein said speaker is received through said opening, said earphone attachment being comprised of an elastomeric material;
a decorative object coupled to said earphone attachment, said decorative object having a first face, a second face and a perimeter wall coupled to and extending between said first face and said second face; and
a coupler removably coupling said earphone attachment to said decorative object, said coupler including a first mating member coupled to said earphone attachment and a second mating member coupled to said decorative object, said first mating member being complementary relative to said second mating member such that said first and second mating members are engageable to releasably couple said earphone attachment to said decorative object, said first mating member being integrally coupled to said earphone attachment, said first mating member comprising a prong extending outwardly from said earphone attachment, said second mating member defining a cavity extending into said decorative object, said prong being received within and engaging said cavity to releasably couple said earphone attachment to said decorative object, said first mating member being attached to said second side of said perimeter surface, said first mating member extending outwardly from said earphone attachment in a direction transverse relative to said longitudinal axis extending through said earphone attachment, said second mating member being coupled to said second face of said decorative object, said first face of said decorative object extending in a first direction when said decorative object is coupled to said earphone attachment, said speaker extending in a second direction opposite said first direction when said ear end of said earphone is attached to said earphone attachment.
